(19) United States
(12) Patent Application Publication
(10) Pub. No.: US 2021/0064592 A1
(43) Pub. Date: Mar. 4, 2021

(54) COMPUTER STORAGE AND RETRIEVAL MECHANISMS USING DISTRIBUTED PROBABILISTIC COUNTING

(71) Applicant: Microsoft Technology Licensing, LLC, Redmond, WA (US)

(72) Inventors: Yida Yao, Gilroy, CA (US); Kiryl Yesipau, Mountain View, CA (US); Tyler Monroe Elliott, Mountain View, CA (US)

(21) Appl. No.: 16/557,652

(22) Filed: Aug. 30, 2019

(51) Int. Cl. G06F 16/22; G06F 16/2453; G06F 17/18

(52) U.S. Cl. CPC G06F 16/2228; G06F 17/18; G06F 16/24535

(57) ABSTRACT

Techniques for computer storage and retrieval mechanisms using distributed probabilistic counting are provided. In one technique, multiple probabilistic data structures (PDSs), each corresponding to a different time range of a plurality of time ranges, are stored. A query is received that includes a key value and a time window. In response to receiving the query, multiple sub-queries are generated, each of which includes the key value and corresponds to a different time range of the time window. Each sub-query corresponds to a different PDS of the multiple PDSs. For each of the multiple sub-queries, that sub-query is executed against the PDS that corresponds to the sub-query. The executing comprises receiving results from the PDS. The results from the multiple sub-queries are aggregated to generate an aggregated result. The query is responded to with the aggregated result.

### TECHNICAL FIELD

The present disclosure relates to data structure count management systems and, more particularly, to counting schemes for distributed data structures.

### BACKGROUND

Without a doubt, big data with nearly boundless applications and utility has gained exceptional notoriety within recent years. Collections of human computer interactions, in the form of digital data, identify popular trends, enable targeted content schemes, and assist in predicting user behavior. Use cases of varying types call for varying requirements. In a feed use case, for example, the number of times a user has visited a website can provide valuable insight into a user's preferences, such as their connections, interests and level of interaction. Collecting and maintaining large data sets requires ample electronic storage space, a rather costly endeavor. Large storage spaces tend to increase latency, a rather inefficient proposition.

Databases often make for attractive storage candidates particularly because a database can be queried to retrieve custom tailored information. A database that maintains user interaction information may be queried, by an application, for user or demographic identification, e.g. identity of users who have visited a particular website more than three times in the last month. Accordingly, large datasets accumulate rather quickly given the large number of application users therefore increasing the size (cost of service) and/or number of requisite databases. Cost of service is not limited to databases. Memory or storage devices, in general, become particularly costly with increased storage space requirements.

Today's count-based solutions can meet use case requirements, albeit inflexibly and inefficiently. Each count of a count element is maintained as an electronic record in a database. It is not inconceivable and rather common practice for an entire database or memory row to be consumed by a single record of a single count making for a large database system. As earlier noted, large databases are costly and suffer from long access times, or latency. A common design around employs key-value databases where only a single key is acquired, and all operations are performed in memory, but this approach has its own drawbacks—infeasibility and impracticality of fitting one record to all databases. Realistically, one count value cannot be made to fit all use cases or countable elements (or countable items of interest). Additionally, to prevent exuberant cost of service, count results are based on a limited recent data set, for example two weeks, and therefore fail to benefit from historical or old data.

One approach to counting is data aggregation with a rolling window where data within a certain recent time period is aggregated and a table is scanned to search for a queried database or memory record. While count accuracy is perfect or near perfect with this approach, data size grows large rather quickly introducing cost issues as earlier noted. Accordingly, old data—data recorded prior to a determined period of time—is practically too large to maintain.

Speed is yet another use case-based design factor. Slow database or memory access times can affect count accuracy, a requirement necessitated by certain use cases. For instance, where database or memory latency exceeds the frequency of user clicks or the frequency of user visits to a website, the resulting count is adversely impacted, effectively rendering the result useless.

Some use cases can tolerate relatively higher error or accuracy rates relative to others. For example, in a scenario where count of the number of times an item has been seen by users, e.g. 800,000 times, yet reported as 850,000, an error deviation of 50,000 may well be tolerated.

Therefore, database accuracy, speed or latency, and size (cost of service) are defining factors for designing a data structure count management system that can be tailored to a particular use case yet today's counting schemes fail to offer corresponding flexible alternatives and instead are limited to a one-size-fits-all solution.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of an example system for distributed probabilistic data structure (PDS) count management, in an embodiment;

FIG. 2 is a flow diagram that depicts an example process for querying data to generate a count result;

FIG. 3 is an example sketch table, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for distributed counting of probabilistic data structures are provided. In one technique, queried probabilistic data structures return count values and the count values are aggregated to provide a count value result. In one technique, probabilistic data sets for determining counts of countable items are queried by leveraging multiple data stores where at least one of the data stores maintains a sketch data structure and the sketch data structure is combined with data from remaining data stores to return a count result. In one technique, at least one of the data stores maintains current data that is combined with sketch data from a different data store to return an aggregated count result.

In a disclosed system and method, multiple data stores include at least one data store with recent (accurate) data, at least one data store with aggregated (inaccurate) data, all data stores with recent data, all data stores with aggregated data, or a combination. In an embodiment where at least one data store includes aggregated data, in response to a query, sub-queries are generated, each with a member pair including a member identification (application user) and a distinct time range identifying a time period during which data is aggregated. Results from the sub-queries are aggregated to generate a count result.

In a disclosed system and method, recent (or current) data and aggregated data are arranged as a set of probabilistic data structure (PDSs). PDS sets may be stored across distinct storage devices or in one storage device. Alternatively, PDS sets may be stored across distinct storage device types, an example of which is across a database and volatile or non-volatile memory. A first set of sub-queries is executed against a recent set of one or more PDSs and a second set of sub-queries is executed against an aggregated set of one or more PDSs. An aggregated count result is determined based on the first and second sub-query results. Sub-queries can be processed in, and results returned, in real time.

A disclosed system and method employ a count min (CM) sketch organized in a sketch table of sketch table cells, each sketch table cell representing a count value. A CM sketch is an example of a PDS. The sketch table cells are accessible by sketch table rows and sketch table columns. A different sketch table row and a different sketch table column addresses a sketch table cell of the sketch table. Each sketch table row corresponds to a distinct hash function and each hash function generates a hash value of an aggregated PDS set. AA ketch table row of sketch table cells of a hash function is provided and the count min of the hash functions, across the sketch table rows, is aggregated into a final result. Because hash functions of the sketch table are independent from one another, and, in an embodiment, hash function count mins can be determined in parallel, increasing system performance.

In accordance with a disclosed system and method, a CM sketch table size remains constant despite the number of countable items. The number of PDS sets, sketch table rows, and sketch table columns may collectively define a count error rate.

Embodiments improve computer-related technology; namely, counting technology. Embodiments facilitate count results based on big data without necessitating large database or memory sizes. Big data is aggregated in the form of sketch data structures with unchanged sketch tables despite countable item numbers and therefore reduce storage space requirements, particularly as data grows. Also, embodiments flexibly apply to various count use cases. Large data sets facilitate use cases with higher error rate tolerance with lower latency and cost of service. Count values for old data facilitate prediction model training with larger data sets and increased prediction accuracy. Embodiments return query results in real time. A constant sketch table size prevents latency concerns.

### System Overview

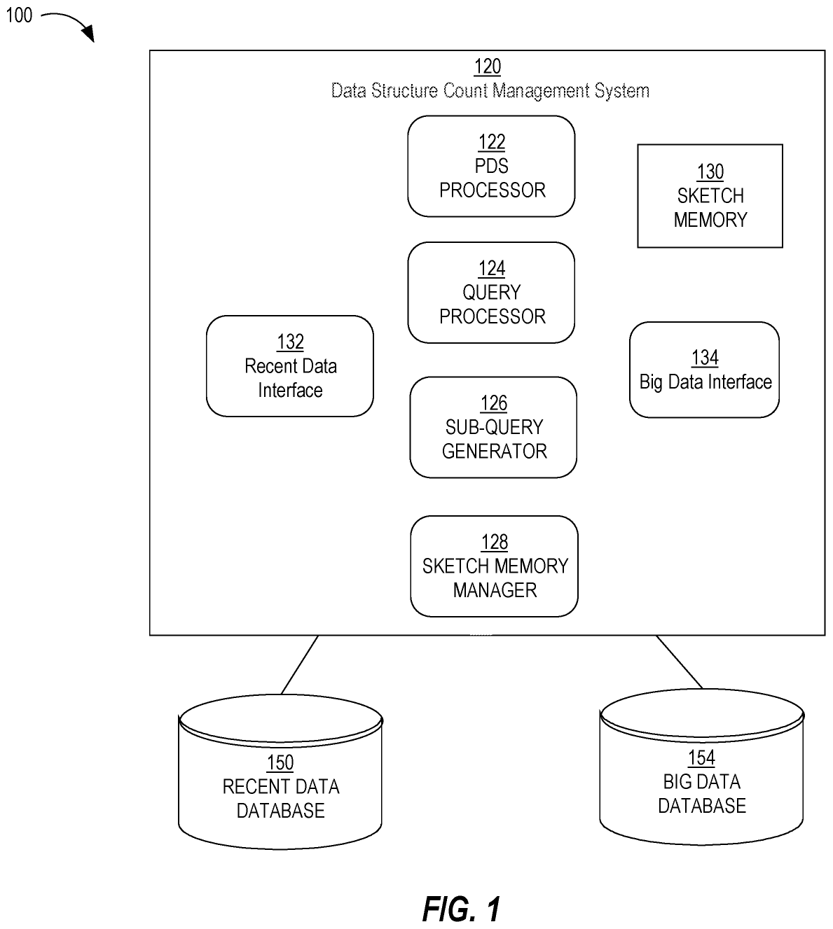

FIG. 1 is a block diagram that depicts a system 100 for distributed probabilistic data structure (PDS) count management, in an embodiment.

Although depicted in a single element, data structure count management system 120 may comprise multiple computing elements and devices, connected in a local network or distributed regionally or globally across many networks, such as the Internet. Thus, data structure count management system 120 may comprise multiple computing elements, including file servers with computing features and database or memory systems. Database or memory systems my comprise one or more storage devices, such as without limitation, databases, persistent memory, and cache memory. For example, data structure count management system 120 includes (1) a PDS processor 122 that manages and processes stored PDS sets, (2) a query processor 124 that receives or generates, manages and processes queries, (3) a sub-query generator 126 that generates time ranged sub-queries from queries received by query processor 124, (4) a sketch memory manager 128 that manages sketch tables saved in database and/or memory, such as in big data database 154 and in sketch memory 130, (5) a recent data interface 132 that manages recent data (current PDS sets) saved in a database, such as a recent data database 150, and (6) a big data interface 134 that manages old (or big) data (old PDS sets) saved in a database, such as big data database 154.

Sketch memory manager 128 causes sketch memory 130 to store sketch tables of count values returned from sub-queries executed against aggregated data.

Recent data interface 132 receives current PDS sets from, and transmits current PDS data sets to, recent data database 150. Big data interface 134 receives big PDS sets from, and transmits big PDS data sets to, big data database 154. Recent data is live data collected as it is generated without aggregation. Recent data is therefore accurate data. Big data is aggregated data that is chronologically older than recent data. In a disclosed method and system, old (or big) data is aggregated into sketches which may include inaccurate data with a higher error rate than the error rate of recent data, which might not have any error rate. In a non-limiting example, recent PDS sets store data that is two weeks old and big PDS sets store data that is older than two weeks. Big data is collected on a rolling basis in database 154 or memory 130. Older data is aggregated with greater data granularity than recent data. A non-limiting example of storing data on a “rolling basis” is at the start of old data collection. For example, on the first day, data is stored every hour. After the first day, data is stored every six hours for the remainder of the first week. After the first week, data is stored once per day, and after two weeks, data is stored once per week, and so on. Unlike recent data, which is live—changing with time, old data remains unchanged with time.

PDS processor 122 coordinates data traffic between recent database 150 and big data database 154 and between big data database 154 and sketch memory 130. Queries cause switching between recent database 150 and big database 154 based on the age of the data being queried. A time window defines a determined time period during which data is collected from one or both databases 150 and 154. Time ranges define query data granularities within a time window. For example, data for a time window of 2 weeks may be queried with 11 sub-queries: 4 with a time range of 6 hours, 6 with a time range of 1 day, and one with a time range of a week.

PDS processor 122 arbitrates the data flow between big data database 154 and sketch memory 130 based on a query or sub-query being executed. During execution of a sub-query, PDS processor 122 reads a sketch table from sketch memory 130 for determining a count result. At a time prior to reading the sketch table, big data interface 134 facilitates retrieving the sketch table from database 154. In an embodiment, big data interface 134 retrieves one or more sketch tables from database 154 with each query. In an embodiment, big data interface 134 need not retrieve any sketch table from database 154 with each query because a previous sketch table that remains saved in sketch memory 130 may be employed in executing a subsequent query.

PDS processor 122 further facilitates serialization and de-serialization of data, as further discussed below.

Query processor 124 generates or receives a query search for data from databases 150 and 154. In an embodiment, query processor 124 automatically generates a query based on certain information. For example, query processor 124 may generate a query automatically based on member identification, countable item, and time range. In an embodiment, query processor 124 receives a user-provided query. For example, query processor 124 may receive a query from PDS processor 122 or other components of system 120 that in turn receive the query from user input.

Sub-query generator 126 generates one or more sub-queries to be processed against database 154 based on a query from query processor 124. In an embodiment, sub-query generator 126 executes or causes execution of sub-queries to database 154 in real time. In an embodiment, sub-query generator 126 generates one or more sub-queries automatically based on data granularity and error rate.

Recent database 150 and big data database 154 may each be a part of data structure count management system 120. Alternatively, one or both reside externally to data structure count management system 120.

In an embodiment, sketch memory 130 may include, in part or in whole, cache memory for faster sketch table access times.

### Probabilistic Data Structures

In disclosed methods and systems, a sub-query is based on knowledge of underlying data structures and the time window they hold. Results of all sub-queries of a query are aggregated for a final count result. In an embodiment, all of the underlying data structures are sketches. Alternatively, some, but not all, of the underlying data structures are sketches with the remaining being accurate counts. Querying accurate data and aggregated data may be performed simultaneously or staggered in time. Simultaneous query of an accurate (or recent) data store and an aggregated (or old) data store increases system performance while staggering them in time may be less resource intensive.

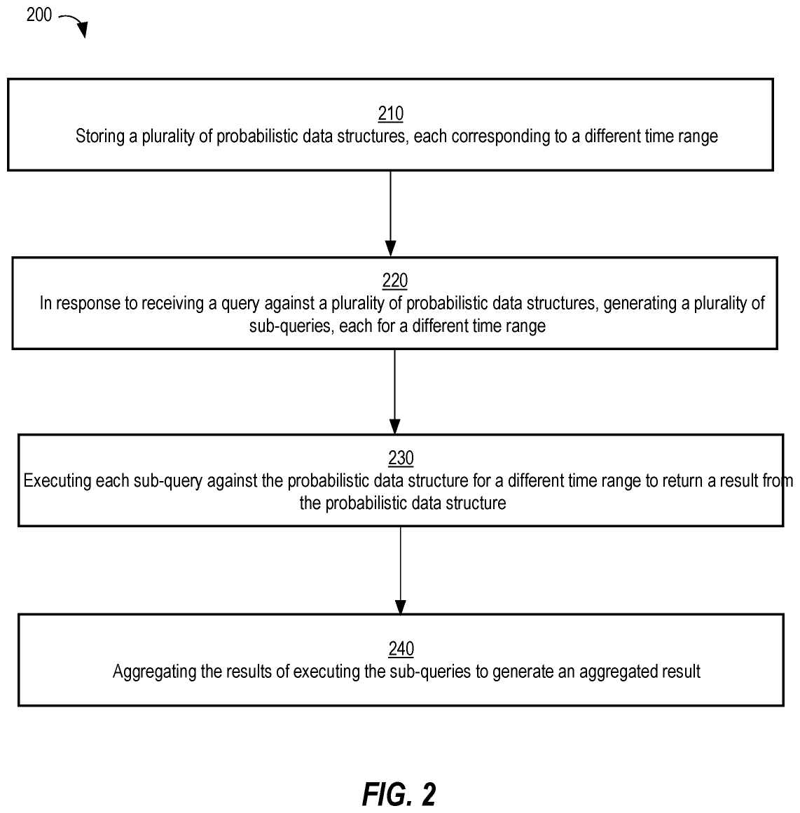

FIG. 2 shows a flow diagram of a disclosed process for querying data to generate a count result. Flow chart 210 includes steps performed by one or more components of data structure count management system 120, and databases 150 and 154. At step 210, PDS processor 122 (FIG. 1) stores PDS sets. In a disclosed method, processor 122 stores PDS sets of recent data in database 150 and PDS sets of big (aggregated) data in database 154. Query processor 124 then initiates a query search of the PDS sets stored in one or both of the databases 150 and 154 at step 210. An example of a query is provided below.

At step 220, in response to receiving a query from step 210, sub-query generator 126 generates one or more sub-queries against the PDS sets stored in database 150, database 154, or a combination of the two databases. In an embodiment with at least one sub-query, generated by sub-query generator 126, against old data, PDS processor 122 retrieves sketch table(s) corresponding to the generated sub-query. In an embodiment, the sub-query specifies a key value and a time range and requests an item count. The time range is a time period of interest for the item count within a time window.

In an embodiment, to accommodate databases, before storing a data structure in the database, the data structure is transformed, byte serialized, and the serialized data is then stored in the database. In disclosed methods and systems, key value is known before data is acquired from databases 150 and 154, for example. A priori key value facilitates fast read operation times relative to conventional counting schemes because the need to scan all records for record-of-interest is alleviated and the record-of-interest is known. For example, referring to the two-week example above, in accordance with traditional counting solutions, two weeks of records must be scanned to determine a count, whereas, disclosed methods and systems go right to the record(s) within the two-week time window.

As earlier noted, key values may be generated or received from a user. In a disclosed method and system, each sub-query includes a key value-time range pair. For example, each sub-query is a member-time range pair: a member identification and a time range. In an embodiment, a key value may include additional information with more than one type of value. Example query from step 210 and example corresponding sub-queries from step 220 for a two-week time window are provided below.

$$Example Query \text{:} ( key value , time window ) = ( \overbrace{countable item , time range}^{Key Value} , \overbrace{time window}^{Time Window} )$$

$$query = ( member ID , time range , time window ) = ( member ID , time range , 2 weeks )$$

Example Sub-query: (key value, time range)=(countable item, time range)

sub-query=(member ID, time range)

Sub-queries (key value, time range):
(member ID, 6 hours)
(member ID, 6 hours)
(member ID, 6 hours)
(member ID, 6 hours)
(member ID, 1 day)
(member ID, 1 day)
(member ID, 1 day)
(member ID, 1 day)
(member ID, 1 day)
(member ID, 1 day)
(member ID, 1 week)

In the above example, a two-week time window is divided into a series of time ranges corresponding to a set of sub-queries. More specifically, the two-week window is divided into subqueries of four 6-hour time ranges, six 1-day time ranges, and one 1-week time range. A sub-query has a key value made of a user identification (ID). A user ID is value associated with and uniquely identifying a member/user. An example of a user is a member of an application interacting with the application, e.g. creating a new application account. Other types of identifiers may form a part of a key value.

In furtherance of the above example, a count is sought for the total number of members with new accounts within the last 6 hours, 1 day, and 1 week (within the 2-week time window). The query search is a key value and time window and the sub-queries are key values and time ranges, each defined by a member-time range pair, or member ID, time range. The member ID identifies the member or user of the application and the time range identifies a time period within the time window during which members have interacted with the application, e.g. created new application accounts. A total of 11 sub-queries are generated or received, as the case may be. The first four subqueries have a time range of 6 hours. Accordingly, the first day of the two-week period is divided into four 6-hour time ranges. For example, the first sub-query for the first 6 hour time period of the first day returns a count value for the number of accounts created during the first 6-hour time period of the first day of the two-week time window, the second sub-query returns a count for the number of accounts created during the subsequent 6-hour time interval following the first 6-hour time interval, the third sub-query returns the number of accounts created during the third 6-hour time range of the first day, and the fourth sub-query returns a count for the number of accounts created during the last six-hour time period of the first day. Each of the following six sub-queries returns the number of new accounts covering the span of a day and the last sub-query returns an aggregated count of opened accounts for the last week of the two-week time window. In this manner, data from database 154 is retrieved on a rolling basis, querying older data with a larger data granularity. In summary, sub-queries are executed against PDS sets of the database 154 for the number of new accounts within the first 6 hours, 1 day, and 1 week of the two-week time window.

Next, at step 230, PDS processor 122 aggregates the results (aggregated counts) returned for each of the sub-queries of step 220, according to corresponding time range in a key value-time range pair, e.g. 6 hours, 1 day, and 1 week, to generate a count result at step 240.

In an embodiment, at step 220, PDS processor 122 first reads CM sketches into sketch memory 130 and then computes the final count value from the CM sketches. In an embodiment, prior to storing data into one or both of the databases 150 and 154, PDS processor 122 serializes the data into bytes and then stores the byte-wise data into a corresponding database and upon retrieval of the data, PDS processor 122 de-serializes the data prior to reading CM sketches into sketch memory 130.

As earlier noted, sub-queries of a query may search different data stores. In the example above, the first four sub-queries may search database 150 for current PDS sets and the following four sub-queries may search old or big PDS sets from database 154, and so on.

Data aggregation generally leads to loss of data granularity. Granularity sets the shortest time interval by which data may be queried. Referring to the two-week example above, data for 2.5 days into the two-week time window is unattainable because no data for the first part or the second part of the third day into the two-week time window is collected and only 1-day aggregated data is available.

### Count Min Sketch

CM sketch is a probabilistic data structure (PDS) that serves as a frequency table of events in a stream of data. It uses hash functions to map events to frequencies, but unlike a hash table, CM sketch uses only sub-linear space, at the expense of overcounting some events due to collisions. The sub-linear number of CM sketch cells is related to the desired approximation quality of the sketch and not the number of countable items. Accordingly, a desired error rate or error tolerance may define the number of rows and columns of a CM sketch table. A CM sketch prevents undercounting or underestimating but it can overcount or overestimate. For this reason, CM sketches are better employed in some applications and not others. Generally, where overestimation may be tolerated but underestimation cannot, CM sketch is a viable counting option.

The goal of a CM sketch is to consume a stream of events, for example the number of user clicks of a specific item, one at a time, and count the frequency of the different types of events in the stream. At any time, the sketch can be queried for the frequency of a particular event type x (0≤x≤n for some n) and will return an estimate of this frequency that is within a certain distance of the true frequency, with a certain probability. Therefore, applications that can tolerate accuracy degradation, e.g. accuracy with a certain error probability, can employ CM sketches, benefiting from decreased data sizes. Sketch tables remain constant in size despite the number of countable items therefore promoting lower latency and smaller data storage space requirements.

A sketch data structure is a two-dimensional array (or table) of “w” columns and “d” rows. The parameters w and d are fixed when the sketch is created and determine the time and storage space requirements in addition to the probability of count error when the sketch is queried for a frequency (or time range). Associated with each of the d rows is a separate hash function; the hash functions are pairwise independent. The parameters w and d can be chosen by setting w=┌e/ε┐ and d=┌ ln 1/δ┐, where the error in answering a query is within an additive factor of E with probability 1-δ, and e is Euler's number.

When a new event of type x arrives, the array is updated as follows: for each row j of the table, the corresponding hash function is applied to obtain a column index k=hⱼ(x). Then the value in row j, column k is incremented by one. The estimated count is given by the least value in the table for x. For each x, the true frequency with which x occurs in the data stream, is less than or equal to the frequency determined from the table, therefore, eliminating the possibility of undercounting.

Additionally, the estimate has a guarantee that the measured frequency with which x occurs in the data stream is less than or equal to the true frequency with which x occurs in the data stream plus εN with probability 1-δ, where N=Σaₓ (for x=0 to x=n) is the stream size, i.e. the total number of countable items in the sketch.

### CM Sketch Table

Disclosed methods and systems leverage sketch into a counting problem solution. Data is compacted into a CM sketch data structure and may be combined with existing (or current) data to generate a count result.

Disclosed methods and systems introduce a PDS in distributed counting to optimize performance and cost of service. Distributed counting is facilitated by storing counts in multiple storage devices and aggregating the multiple stored counts to generate a count value. In an embodiment, as further discussed below, hash functions are based on counts distributed among various storage devices and corresponding hash values are aggregated to generate a count result. Accordingly, different machines are queried, and the results of the queries are aggregated for a final count tally. In an embodiment, multiple CM sketches are queried from one or more storage devices at the same time to improve system performance.

Alternatively, disclosed methods and systems accommodate single source counting problems where a common CM sketch maintains aggregated data without which a single long query would need to be determined leading to greater latency and lower system performance. An example application of single source counting is privacy conformance requiring maintaining historical data in perpetuity.

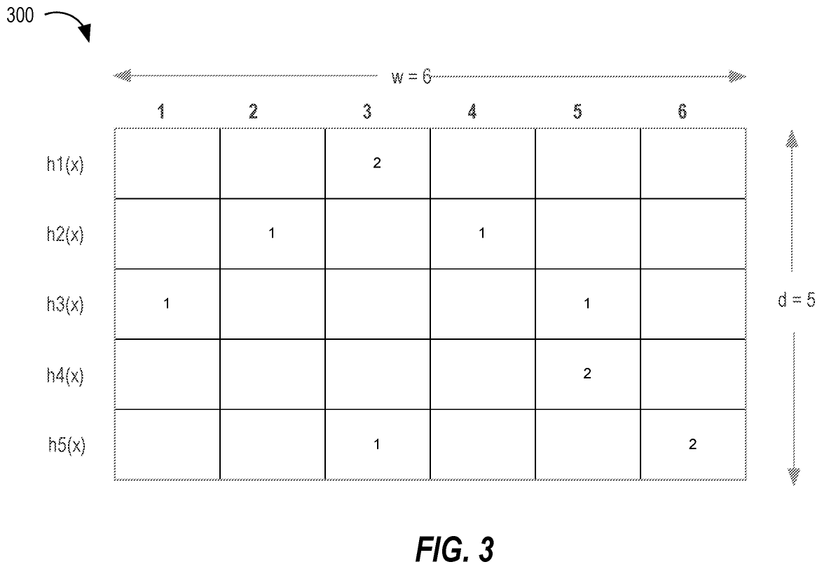

FIG. 3 shows an example sketch table of a disclosed system and method. In a disclosed system and method, CM sketch table 300 is arranged in sketch table rows and sketch table columns. A CM sketch table row represents distinct hash functions. In a disclosed system and method, table 300 is a CM sketch table with ‘N’ number of hashed elements, ‘x’ representing input to the table 300, ‘w’ representing the number of sketch table columns, and ‘d’ representing the number of sketch table rows.

In table 300, query results are obtained for all x's of aggregated data from memory or big data store (such as database 154 in FIG. 1). In an embodiment, query results are obtained for some but not all x's of aggregated data from memory or big data store data and in still other embodiments, query results are obtained for all x's from recent data store (such as database 150 in FIG. 1). A minimum value of the CM sketch is determined for each sub-query and the resulting sub-query minimums are aggregated to determine the count result.

In the example of FIG. 3, x may be counted in a feed use case representing the number of times a user has visited a website. As earlier noted, “x” in table 300 is the feed or countable item and the count value is the value of a cell of the table 300 and stored in database 154. “H” is the hash function based on an applicable hashing method. Each sketch table row represents a distinct hash function. For example, the first row of table 300 represents hash function h₁(x), the second row of table 300 represents hash function h₂(x) and so on to hash function h₅(x). Table 300 starts with all count values, i.e. values in a sketch table cell, being 0s. Each time the user visits the website, the count value is incremented by one and the incremented count value replaces the existing count value. Accordingly, a count value in a sketch table cell corresponds to the hash function multiple times.

Table 300 starts with all cells having a value of 0. The table counts whenever the user visits the website (or takes action). Each hash value from a different hash function results in a different row in a (new) data structure. Hash values for different hash functions cannot hit the same row; they will hit different rows. H(x) is a representation of determining which sketch table column is being written to. For example, where h₁(x)=3, the hash value for column 3 is determined. In an embodiment, the number of columns (“w” or the number of items to be hashed, ‘6’ in table 300) and the number of rows (“d” which is 5 in table 300) determine the count error rate, the rate by which the approximated and true frequencies differ. The size of the data structure does not affect the size of table 300, as previously noted, but the larger the data structure size, the lower the error rate. In table 300, when for the same hash function, a new hash value is provided, the current hash value is incremented by one. “N” is the number of countable items. In an embodiment, “N” is cardinality, or the number of items being counted in a data structure. The larger N becomes, the greater the number of collisions, and therefore the larger the count error.

Referring still to table 300, the hash value, or minimum value, for each hash function is as follows: h₁(x)=2, h₂(x)=1, h₃(x)=1, h₄(x)=2, and h₅(x)=1 and an aggregate minimum of all hash functions is 1. Therefore, the final count result equals one.

While in examples herein, one countable item is employed, it is understood that any number of countable items is possible. The number of countable items does not change the sketch table size. Taking the minimum value ensures against underestimation, as previously noted.

### Aggregated Data Store and Accurate Data Store

Queries that require counts of certain items by leveraging multiple data stores where at least one of them is a sketch data structure can be combined with more current data. After a certain time period, recent data processing switches to aggregated data processing. Recent data is accurate or correct (and live) data whereas old data is aggregated and less accurate. Old data does not change; therefore, the data structure can be defined such that the error rate is low (acceptable) and the data structure is compact at the same time.

In disclosed methods and systems, different sizes of CM sketches may be tested to develop a tolerated error rate. In an embodiment, error rate can be determined through empirical test results from human behavior. For example, a test of whether 5% of users or 20% of users respond positively to a scenario may lead to choosing the higher error rate. Results of tests of users' behavior with a 5% error rate on 50% of the users and a 20% error rate on the remaining 50% of the users may yield indifference in which case, a higher error rate may be tolerated. That is, upon observing how members behave under these two test cases, an acceptable error rate may be determined. Accordingly, how users interact with an application may define the error rate. For example, if user predictions based on older data with higher error rate provide the same click-through rate (CTR) as users looking at recent data with lower error rate, i.e. CTR predictions are the same, then users clearly do not care and a higher error rate data is tolerable. While a higher error rate has the effect of decreasing accuracy, it also has the effect of reducing storage space requirements and latency. “W” and “d” may then be determined according to the acceptable error rate.

In an embodiment, counts are retrieved in real time from storage or memory leading to reduced latency.

In accordance with disclosed methods and systems, CM sketch counting techniques have shown ten times the latency improvement and five times the storage space savings over their counterpart traditional counting techniques.

In some embodiments, a new counting scenario may not require generating a new set of sub-queries because the CM sketch from a previous count includes the data required by the new count. The CM sketch that was previously generated is read from memory, such as from sketch memory 130, bypassing database data retrieval, to determine the new count.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

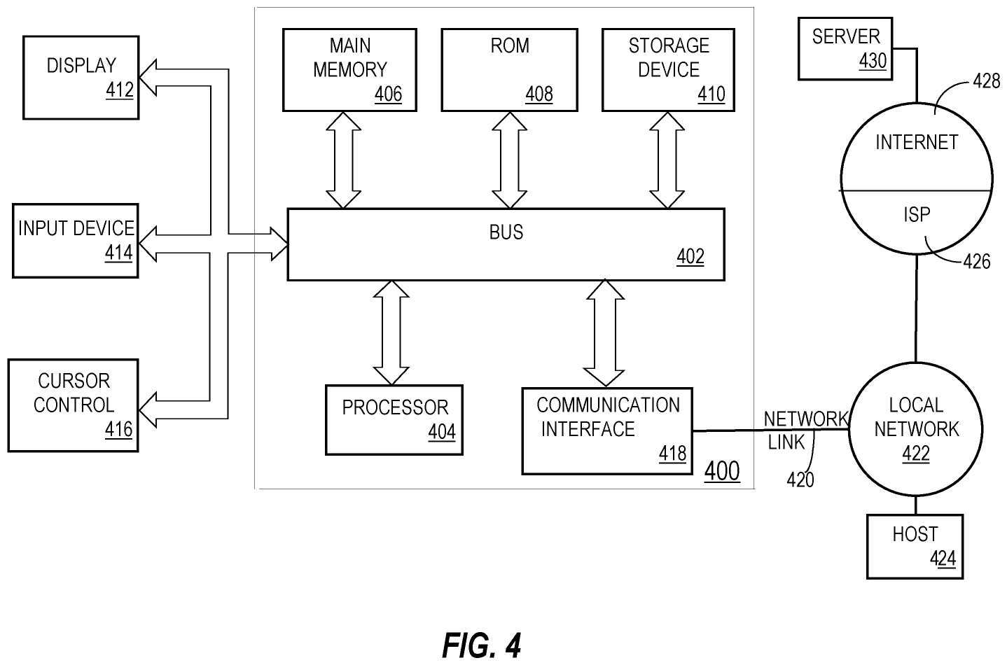

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a plurality of probabilistic data structures (PDSs), each corresponding to a different time range of a plurality of time ranges;
receiving a query that includes a key value and a time window;
in response to receiving the query:
generating a plurality of sub-queries, each of which includes the key value and corresponding to a different time range of the time window;
wherein each sub-query of the plurality of sub-queries corresponds to a different PDS of the plurality of PDSs;
for each sub-query of the plurality of sub-queries, executing said each sub-query against the PDS that corresponds to said each sub-query, wherein executing comprises receiving results from the PDS;
aggregating the results from the plurality of sub-queries to generate an aggregated result;
responding to the query with the aggregated result;
wherein the method is performed by one or more computing devices.

2. The method of claim 1, wherein the plurality of PDSs is stored across different storage space devices or different storage device types.

3. The method of claim 1, further comprising:
storing a recent set of PDSs of the plurality of PDSs and an aggregated set of PDSs of the plurality of PDSs; and
executing a first set of one or more sub-queries of the plurality of sub-queries against the recent set of PDSs of the plurality of PDSs and executing a second set of one or more sub-queries of the plurality of sub-queries against the aggregated set of PDSs of the plurality of PDSs.

4. The method of claim 1, wherein at least one of the plurality of PDSs is a count min (CM) sketch.

5. The method of claim 4, wherein the CM sketch comprises a sketch table arrangement of a plurality of sketch table cells accessible by a plurality of sketch table rows and sketch table columns, a different sketch table row of the plurality of sketch table rows and a different sketch table column of the plurality of sketch table columns addressing said each sketch table cell of the plurality of sketch table cells, said each sketch table row of the plurality of sketch table rows corresponding to a different hash function of a plurality of hash functions, said each hash function corresponding to a hash value of an aggregated set of PDSs.

6. The method of claim 5, further comprising, aggregating the hash values corresponding to the plurality of hash functions to generate a count result.

7. The method of claim 5, further comprising maintaining a CM sketch table size defined by the plurality of sketch table rows and a plurality of sketch table columns of a CM sketch of aggregated sets of PDSs with different set sizes, wherein a number of sketch table rows of the plurality of sketch table rows and a number of sketch table columns of the plurality of sketch table columns define an error rate associated with the aggregated result.

8. The method of claim 1, further comprising querying the plurality of PDSs in real time.

9. The method of claim 1, further comprising executing the plurality of sub-queries corresponding to the plurality of PDSs in parallel or staggered in time.

10. The method of claim 1, further comprising automatically generating one or more sub-queries of the plurality of sub-queries based on data granularity and count error rate.

11. One or more storage media storing instructions which, when executed by one or more processors, cause:
storing a plurality of probabilistic data structures (PDSs), each corresponding to a different time range of a plurality of time ranges;
receiving a query that includes a key value and a time window;
in response to receiving the query:
generating a plurality of sub-queries, each of which includes the key value and corresponding to a different time range of the time window;
wherein each sub-query of the plurality of sub-queries corresponds to a different PDS of the plurality of PDSs;
for each sub-query of the plurality of sub-queries, executing said each sub-query against the PDS that corresponds to said each sub-query, wherein executing comprises receiving results from the PDS;
aggregating the results from the plurality of sub-queries to generate an aggregated result;
responding to the query with the aggregated result.

12. The one or more storage media of claim 11, wherein the plurality of PDSs is stored across different storage space devices or different storage device types.

13. The one or more storage media of claim 11, wherein the instructions, when executed by the one or more processors, further cause:
storing a recent set of PDSs of the plurality of PDSs and an aggregated set of PDSs of the plurality of PDSs; and
executing a first set of one or more sub-queries of the plurality of sub-queries against the recent set of PDSs of the plurality of PDSs and executing a second set of one or more sub-queries of the plurality of sub-queries against the aggregated set of PDSs of the plurality of PDSs.

14. The one or more storage media of claim 11, wherein at least one of the plurality of PDSs is a count min (CM) sketch.

15. The one or more storage media of claim 14, wherein the CM sketch comprises a sketch table arrangement of a plurality of sketch table cells accessible by a plurality of sketch table rows and sketch table columns, a different sketch table row of the plurality of sketch table rows and a different sketch table column of the plurality of sketch table columns addressing said each sketch table cell of the plurality of sketch table cells, said each sketch table row of the plurality of sketch table rows corresponding to a different hash function of a plurality of hash functions, said each hash function corresponding to a hash value of an aggregated set of PDSs.

16. The one or more storage media of claim 15, wherein the instructions, when executed by the one or more processors, further cause aggregating the hash values corresponding to the plurality of hash functions to generate a count result.

17. The one or more storage media of claim 15, wherein the instructions, when executed by the one or more processors, further cause maintaining a CM sketch table size defined by the plurality of sketch table rows and a plurality of sketch table columns of a CM sketch of aggregated sets of PDSs with different set sizes, wherein a number of sketch table rows of the plurality of sketch table rows and a number of sketch table columns of the plurality of sketch table columns define an error rate associated with the aggregated result.

18. The one or more storage media of claim 11, wherein the instructions, when executed by the one or more processors, further cause querying the plurality of PDSs in real time.

19. The one or more storage media of claim 11, wherein the instructions, when executed by the one or more processors, further cause executing the plurality of sub-queries corresponding to the plurality of PDSs in parallel or staggered in time.

20. The one or more storage media of claim 11, wherein the instructions, when executed by the one or more processors, further cause automatically generating one or more sub-queries of the plurality of sub-queries based on data granularity and count error rate.
